(19) United States
(12) Patent Application Publication
(10) Pub. No.: US 2008/0174229 A1
(43) Pub. Date: Jul. 24, 2008

(54) Composition for forming electron emission sources, method of manufacturing the same, and electron emission sources and electron emission device manufactured using the method

(76) Inventor: Kwang-Seok Jeong, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/790,764

(22) Filed: Apr. 27, 2007

(30) Foreign Application Priority Data
Apr. 28, 2006 (KR) 10-2006-0038858

(51) Int. Cl. H01J 1/62

(52) U.S. Cl. 313/495

(57) ABSTRACT

An electron emission device includes a base substrate, first electrodes on the base substrate, second electrodes electrically insulated from the first electrodes, a first insulation layer between the first electrodes and the second electrodes, electron emission source holes formed in the first insulation layer and the second electrodes to expose the first electrodes, and electron emission sources in the electron emission source holes, each electron emission source including at least one electron emission material and at least one catalyst metal nano particle.

### BACKGROUND OF THE INVENTION

1. Field of the Invention

The present invention relates to a composition for forming electron emission sources, a method of manufacturing the same, electron emission sources and an electron emission device manufactured using the method. More particularly, the present invention relates to electron emission sources having improved electron emission efficiency by uniformly disposing electron emission materials on a surface of the electron emission sources, an electron emission device formed from the electron emission sources, a method of manufacturing the electron emission device, and a composition for forming the electron emission sources.

2. Description of the Related Art

In general, electron emission devices use a thermal cathode or a cold cathode as an electron emission source. Electron emission devices that use the cold cathode include, e.g., field emission device (FED) type electron emission devices, surface conduction emitter (SCE) type electron emission devices, metal-insulator-metal (MIM) type electron emission devices, metal-insulator-semiconductor (MIS) type electron emission devices, ballistic electron surface emitting (BSE) type electron emission devices, etc.

FED devices may be readily emit electrons due to a field emission difference in a vacuum when a material having a low work function or a high β function is used as an electron emission source. Electron emission sources may have a sharp tip and may be formed of, e.g., molybdenum, silicon, etc., as a main material. Electron emission sources may also be formed from a carbon material, e.g., graphite, diamond like carbon (DLC), etc., or a nano material, e.g., a nano tube, a nano wire, etc.

SCE devices may emit electrons from an electron emitter formed from the fine gap by applying a voltage to the first and second electrodes and flowing a current to the surface of the conductive thin film. SCE devices may include a conductive thin film between a first electrode and a second electrode facing each other on a substrate, and a fine gap may be created on the conductive thin film.

MIM and MIS devices may employ electron emission sources having MIM and MIS structures, and electrons may be emitted and accelerated from a metal or a semiconductor having high electron potential toward a metal having a low electron potential, when a voltage is applied between two metals or a metal and a semiconductor which have a dielectric layer interposed therebetween.

BSE devices may emit electrons by forming an electron supply layer formed from a metal or a semiconductor on an ohmic electrode, and an insulation layer and a metal thin film may be formed on the electron supply layer. Power may be applied to the ohmic electrode and the metal thin film to induce electron emission. In BSE devices, electrons may not be dispersed but may travel when a semiconductor is reduced to a dimensional region smaller than a mean free travel distance of the electrons in the semiconductor.

FED devices may use a pointed carbon material as the electron emitter, as mentioned above. When the electron emitter formed from the carbon material is manufactured using a general method, the carbon material or the nano material forming the electron emitter may not be exposed to the surface of the electron emitter but may instead be buried in the electron emitter. Therefore, the electron emitter may not be effectively used.

However, although the carbon material or the nano material is partially projected toward the surface of the electron emitter, electrons may not be emitted in an upper end projection, but in a lateral end projection. Therefore, electrons may not be uniformly emitted.

When end portions of electron emission materials are not spaced apart from each other by a predetermined gap, the closely packed electron emission materials may interact with an electron emission material having a large diameter, which may cause a screen effect such that electron emission characteristics deteriorate due to a large slenderness ratio.

Therefore, since the electron emission characteristics may deteriorate and a screen may not be uniform, a technology is desired to reduce or eliminate the above problems.

The above information disclosed in this Background section is only for enhancement of understanding of the background of the invention, and therefore it may contain information that does not form the prior art that is already known in this country to a person of ordinary skill in the art.

### SUMMARY OF THE INVENTION

The present invention is therefore directed to an electron emission device, a method of making the electron emission device, a composition for forming electron emission sources, and an electron emission source, which substantially overcome one or more of the problems due to the limitations and disadvantages of the related art.

It is therefore a feature of an embodiment of the present invention to provide electron emission sources that may prevent a screen effect and improve electron emission efficiency, and an electron emission device, a method of manufacturing the electron emission device, and a composition for forming the electron emission sources.

It is therefore another feature of an embodiment of the present invention to provide electron emission sources that may have improved electron emission efficiency by uniformly disposing electron emission materials on a surface of the electron emission sources, and an electron emission device, a method of manufacturing the electron emission device, and a composition for forming the electron emission sources.

At least one of the above and other features and advantages of the present invention may be realized by providing an electron emission device which may include a base substrate, first electrodes on the base substrate, a first insulation layer on the first electrodes, second electrodes on the first insulation layer, the first insulation layer electrically insulating the first and second electrodes, electron emission source holes formed in the first insulation layer and the second electrodes to expose the first electrodes, and electron emission sources in the electron emission source holes, each electron emission source including at least one electron emission material and at least one catalyst metal nano particle.

The catalyst metal nano particles may be formed of at least one of Fe, Co, or Ni. An average diameter of the catalyst metal nano particles may be in the range of about 1 nm to about 10 nm, or in a range of about 1 nm to about 5 nm. The electron emission device may also include a second insulation layer on second electrodes, and a collimating electrode on the second insulation layer. The electron emission device may also include a front substrate separated from the base substrate by spacers, a third electrode on the front substrate, and phosphor layers on the third electrode, the phosphor layers corresponding to the electron emission sources. At least one of the phosphor layers may be a red light emitting phosphor layer formed from SrTiO₃:Pr, Y₂O₃:Eu, or Y₂O₃S:Eu. At least one of the phosphor layers may be a green light emitting phosphor layer formed from Zn(Ga, Al)₂O₄:Mn, Y₃(Al, Ga)₅O₁₂:Tb, Y₂SiO₅:Tb, or ZnS:Cu,Al. At least one of the phosphor layers may be a blue light emitting phosphor layer formed from Y₂SiO₅:Ce, ZnGa₂O₄, or ZnS:Ag,Cl. The catalyst metal nano particles may further include at least one carbon nano tube.

At least one of the above and other features and advantages of the present invention may be realized by providing a method of manufacturing an electron emission device, which may include preparing a composition, the composition including catalyst metal nano particles, coating the composition on first electrodes to form a layer, and growing electron emission materials from the catalyst metal nano particles.

The method may further include exposing the layer, partially hardening the layer, and baking the layer. The coating the composition may include preparing a base substrate, forming first electrodes extending in a direction on the base substrate, forming a first insulation layer to cover the first electrodes, forming second electrodes on the first insulation layer to cross the first electrodes, forming electron emission source holes to expose the first electrodes and the second electrodes, and coating the layer of the composition on the base substrate and the electron emission source holes. The coating the composition may include preparing a base substrate, forming first electrodes extending in a direction on the base substrate, forming an insulation layer to cover the first electrodes on the base substrate, forming second electrodes on the first insulation layer to cross the first electrodes, forming a second insulation layer to cover the first electrodes, forming a collimating electrode on the second insulation layer, forming electron emission source holes to expose the first electrodes, the second electrodes, the second insulation layer, and the collimating electrode, and coating the layer of the composition on the base substrate and the electron emission source holes. The composition may be formed by dispersing massive polar and non-polar molecules and catalyst metal particles in a vehicle.

At least one of the above and other features and advantages of the present invention may be realized by providing a composition for forming electron emission sources which may include a dispersion of polar and non-polar massive molecules and catalyst metal particles in a vehicle. The vehicle may include at least one resin selected from cellulose resin, acrylate resin, or vinyl resin, and at least one solvent selected from terpineol, butyl carbitol, butyl carbitol acetate, or 2,2,4-trimethyl-1,3-pentanediol monoisobutyrate.

At least one of the above and other features and advantages of the present invention may be realized by providing an electron emission source which may include catalyst metal nano particles, and at least one electron emission material grown from the catalyst nano particles.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a partially exploded perspective view of an electron emission device according to an embodiment of the present invention;

FIG. 2 illustrates a cross-sectional view taken along a line II-II of FIG. 1;

FIG. 3 illustrates an enlarged view of a portion III of FIG. 2;

FIG. 4 illustrates a partially exploded perspective view of an electron emission device according to an embodiment of the present invention; and

FIG. 5 illustrates a cross-sectional view taken along a line IV-IV of FIG. 4.

### DETAILED DESCRIPTION OF THE INVENTION

Korean Patent Application No. 10-2006-0038858, filed on Apr. 28, 2006, in the Korean Intellectual Property Office, and entitled: “Composition for Forming Electron Emission Sources, Method Of Manufacturing the Same, and Electron Emission Sources and Electron Emission Device Manufactured Using the Method,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

According to an electron emission device and a method of manufacturing the electron emission device of the present invention, electron emission materials, e.g., a carbon material, included in an electron emission device may be grown to be spaced apart from each other on the surface of electron emission sources, and simultaneously, multiple carbon nano tubes (CNTs) may be grown in or on a catalyst metal nano particle, spaced apart from each other by a surface curvature of the catalyst metal nano particle. The above characteristics may avoid the screen effect that may occur when the CNTs are grown in a condensed manner. Also, a method of manufacturing the electron emission devices of the present invention may grow the CNTs, which are electron emission materials, at a relatively low temperature.

The present invention will now be described more fully with reference to the accompanying drawings in which exemplary embodiments of the invention are shown.

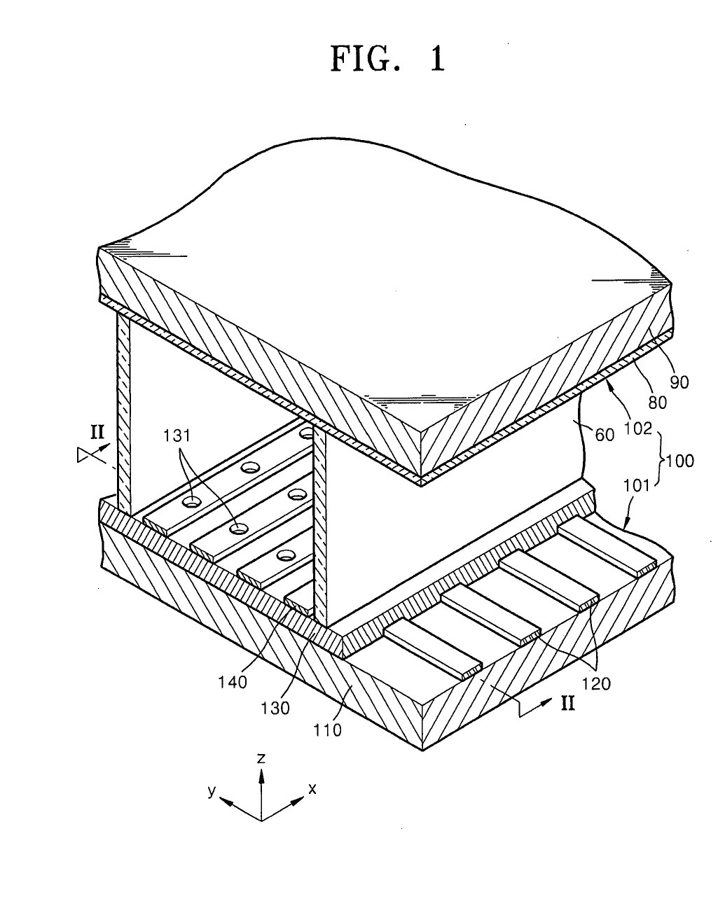

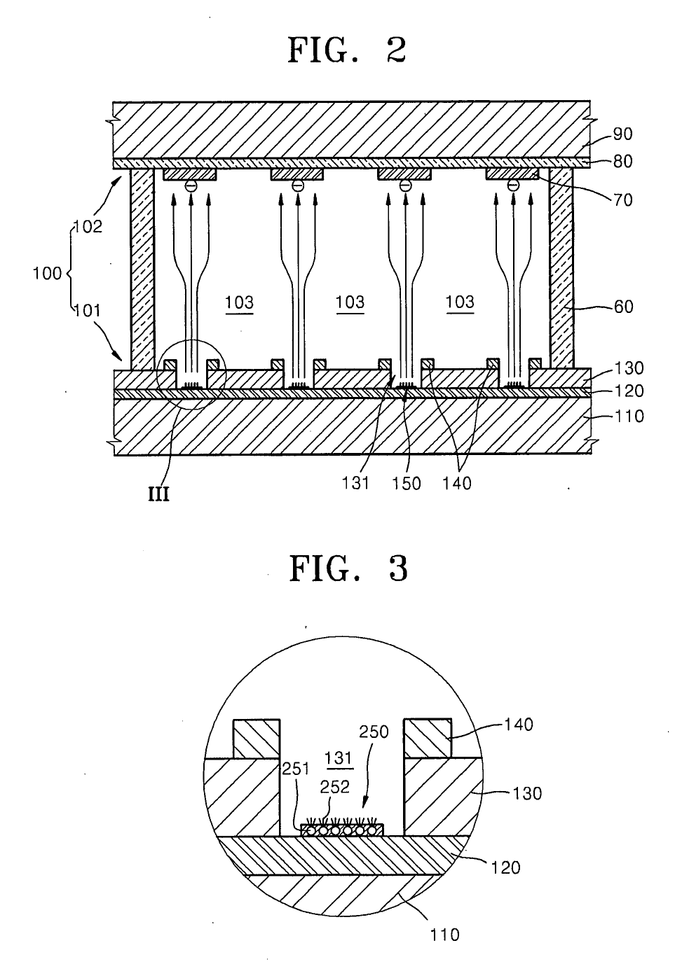

FIG. 1 illustrates a partially exploded perspective view of an electron emission device 101 according to an embodiment of the present invention. FIG. 2 illustrates a cross-sectional view taken along a line II-II of FIG. 1. FIG. 3 illustrates an enlarged view of a portion III of FIG. 2.

Referring to FIGS. 1 through 3, an electron emission device 101 may include a base substrate 110, cathodes 120, gate electrodes 140, a first insulating layer 130, and electron emission sources 250.

The base substrate 110 may be a board having a predetermined thickness, and may be formed of, e.g., quartz glass, glass containing a small amount of impurity, such as Na, borosilicate glass, phosphate glass, sheet glass, glass coated with SiO₂, oxide aluminum, ceramic, etc. When a flexible display apparatus is desired, the base substrate 110 may be formed of a flexible material.

The cathodes 120 may extend in a direction on the base substrate 110, and may be formed of a conventional electrically conductive material, e.g., at least one metal including Al, Ti, Cr, Ni, Au, Ag, Mo, W, Pt, Cu, Pd, and an alloy of these metals. The cathodes may also be formed from alloys or oxides, e.g., RuO₂, Pd—Ag, etc. The cathode 120 may additionally be formed from, e.g., a printed conductive material formed of metal oxide and glass, a transparent conductive material including ITO, In₂O₃, or SnO₂, or a semiconductor material such as polysilicon, etc.

The gate electrodes 140 may be insulated from the cathodes 120 by the insulating layer 130. The gate electrodes 140 may be formed of a conventional electrically conductive material similar to that of the cathodes 120. The first insulating layer 130 may be interposed between the gate electrodes 140 and the cathodes 120 to provide insulation, thereby preventing short circuits between the gate electrodes 140 and the cathodes 120.

The electron emission sources 250 may be electrically connected to the cathodes 120, and may be lower than the gate electrodes 140. The electron emission sources 250 may include electron emission materials 252 and catalyst metal nano particles 251. The electron emission materials 252 may be composed of carbon nano tubes (CNT) grown from the catalyst metal nano particles 251. The CNT has a low work function, a high β function, and excellent electron emission characteristics. The electron emission sources 250 may be formed of carbon materials, e.g., graphite, diamond, diamond like carbon, etc., or the electron emission sources 250 may be formed from nano materials such as nano wires, nano rods, etc.

The catalyst metal nano particles 251 may be formed of at least one material selected from, e.g., Fe, Co, Ni, etc. The catalyst metal nano particles 251 may have an average diameter from several nanometers to several hundreds of nanometers. In particular, an average diameter of the catalyst metal nano particles 251 may be in a range of about 1 nm to about 10 nm, and more preferably, in a range of about 1 nm to about 5 nm.

The electron emission device 101 having the above structure may apply a negative (−) voltage to the cathodes 120 and a positive (+) voltage to the gate electrodes 140 in order to emit electrons from the electron emission sources 250 by using an electric field formed between the cathodes 120 and the gate electrodes 140. The electron emission device 101 may also emit electrons by applying the positive (+) voltage to the cathodes 120 and the negative (−) voltage to the gate electrodes 140.

The electron emission device 101 may be used in an electron emission display device 100 that generates visible light and displays an image. To form the electron emission display device 100, a phosphor substance may be formed on the front of the electron emission sources 250 of the electron emission device 101. The electron emission display device 100 may further include a front panel 102 parallel to the base substrate 110. The front panel 102 may include a front substrate 90, an anode 80 on the front substrate 90, and phosphor layers 70 on the anode 80.

The front substrate 90 may be a board member having a predetermined thickness, similar to the base substrate 110. The front substrate 90 may be formed of the same material as the base substrate 110. The anode 80 may be formed of a conventional electrically conductive material similar to the cathodes 120 and the gate electrodes 140. The phosphor layers 70 may be formed of a cathode luminescence (CL) type phosphor substance that generates visible light when excited by accelerated electrons. The phosphor layers 70 may employ phosphors for emitting different colors. Red light emitting phosphors may include, e.g., SrTiO₃:Pr, Y₂O₃:Eu, Y₂O₃S:Eu, etc. Green light emitting phosphors may include, e.g., Zn(Ga, Al)₂O₄:Mn, Y₃(Al, Ga)₅O₁₂:Tb, Y₂SiO₅:Tb, ZnS:Cu,Al, etc. Blue light emitting phosphors may include, e.g., Y₂SiO₅:Ce, ZnGa₂O₄, ZnS:Ag,Cl, etc. However, the phosphors of the present invention are not limited thereto, and any appropriate phosphor may be used.

The cathodes 120 and the gate electrodes 140 may cross each other so that the visible light may display an image, rather than emitting light similar to a lamp. Electron emission source holes 131 may be formed in regions where the cathodes 120 and the gate electrodes 140 cross each other in order to house the electron emission sources 250 therein.

The electron emission device 101 may include the base substrate 110, and the front panel 102 may include the second substrate 90. The base substrate 110 and the front panel 102 may be spaced apart from each other by a predetermined gap and form light-emitting spaces. Spacers 60 may be formed to maintain a distance between the electron emission device 101 and the front panel 102. The spacers 60 may be formed of an insulating material.

Also, frit seals may be arranged around light-emitting spaces 103 formed by the electron emission device 101 and the front panel 102. Air in the light-emitting spaces 103 may be exhausted to create a vacuum in the light-emitting spaces. The operation of the electron emission display device 100 having the above structure will now be described.

A negative (−) voltage may be applied to the cathodes 120 and a positive (+) voltage may be applied to the gate electrodes 140 in order to emit electrons from the electron emission source 250 formed on the cathodes 120. Also, a strong positive (+) voltage may be applied to the anode 80 to accelerate the electrons toward the anode 80. Therefore, electrons may be emitted from the electron emission materials 252 forming the electron emission source 250. The emitted electrons may travel toward the gate electrodes 140, and then, may accelerate toward the anode 80. The electrons accelerated toward the anode 80 may collide with the phosphor layers 70, excite the phosphor layers 70, and generate visible light.

A method of manufacturing the electron emission device 101 according to an embodiment of the present invention will now be described.

The base substrate 110, the cathode 120, the insulating layer 130, and the gate electrode 140 may be sequentially stacked to a predetermined thickness. A process such as screen printing may be used to form the stack.

A mask pattern (not shown) having a predetermined thickness may be formed on a top surface of the gate electrode 140. The mask pattern may be required to form the electron emission source holes 131 using a photolithography process that coats a photo resist (PR) on the gate electrode 140 and the insulating layer 130. Ultraviolet or E-beam photolithography may be used.

The gate electrode 140 and the first insulation layer 130 may be etched using the mask pattern to form the electron emission source holes 131. An etching process may be a hydro-etching process that uses an etching liquid according to a material, a thickness, etc., of the gate electrode 140 and the insulation layer 130. Other etching processes that may be used include, e.g., a pyro-etching process which uses a corrosive gas, a micro-machining process which uses ion beam, etc.

A photoresist layer may be formed to cover the gate electrode 140 and the insulation layer 130. Thereafter, a composition for forming the electron emission source including catalyst metal nano particles may be manufactured. The composition for forming the electron emission source may be manufactured by dispersing massive molecules, which may include polar molecules and non-polar molecules, and catalyst metal particles in a vehicle. The massive molecules may be obtained by combining molecules having an ionic structure with, e.g., a carbon chain, a phenyl group, a benzene group, etc. The vehicle may be formed of, e.g., a resin component and a solvent component. The polar and non-polar molecules may be apparent in the final product. These polar and non-polar molecules may be found by chemically analyzing the electron emission source of the final product with an appropriate method, e.g., infrared spectroscopy, ultraviolet spectroscopy, nuclear magnetic resonance spectroscopy, Raman spectroscopy, etc.

The resin component may include at least one of, e.g., a cellulose group resin such as ethylcellulose, nitrocellulose, etc., an acrylic group resin such as polyester acrylate, epoxy acrylate, urethane acrylate. etc., or a vinyl group resin such as polyvinyl acetate, polyvinyl butyral, polyvinyl ether, etc. However, the present invention is not limited thereto, and any appropriate resin component may be used. Some of the aforementioned resin components may simultaneously serve as a photosensitive resin.

The solvent component may include at least one of, e.g., terpineol, butyl carbitol (BC), butyl carbitol acetate (BCA), toluene, or TEXANOL (2,2,4-trimethyl-1,3-pentanediol monoisobutyrate), etc. The solvent component may preferably include, e.g., terpineol. If the content of the solvent component is extremely low or high, the composition for forming the electron emission sources may deteriorate in terms of printing and flow characteristics. In particular, if the solvent content of the vehicle is extremely high, the drying time may be extremely lengthened. The solvent content in the vehicle may be from about 5 wt % to about 20 wt %.

If the catalyst metal nano particles and the massive molecules, including the polar molecules and/or non-polar molecules, are mixed in the vehicle, a portion having a polarity of the massive molecules may be combined with the catalyst metal nano particles, and a portion without the polarity of the massive molecules may not be combined with the catalyst metal nano particles, so that the catalyst metal nano particles may be actively dispersed in the vehicle. As a result, the catalyst metal nano particles may not be combined in the vehicle, but may be dispersed so that the CNTs may be grown spaced apart from each other. However, the method of dispersing the catalyst metal nano particles in the vehicle is not limited thereto, and any appropriate method may be used.

The composition for forming the electron emission sources may be coated in the electron emission source holes 131 to form a layer. A coating process can be performed by employing, e.g., screen printing.

Next, the layer of the composition for forming the electron emission sources may be exposed to ultraviolet light, partially hardened, and baked to form desired forms of the electron emission sources. The wavelength of the ultraviolet light may be about 365 nanometers. The baking process may create the catalyst metal nano particles exposed on the surface of the electron emission sources.

The CNTs may be grown using, e.g., a chemical vapor deposition (CVD) direct growth method employing the catalyst metal nano particles included in the electron emission sources. The CNTs may be grown on the surface of a catalyst metal included in the layer of the composition for forming the electron emission sources, and the CNTs may condense so that the CNTs no longer exist. Also, although the catalyst metal nano particles are not rectangular, since the surfaces of the catalyst metal nano particles have a predetermined curvature, the end portions of the CNTs may be grown to be spaced apart from each other, thereby avoiding the screen effect and improving electron emission efficiency.

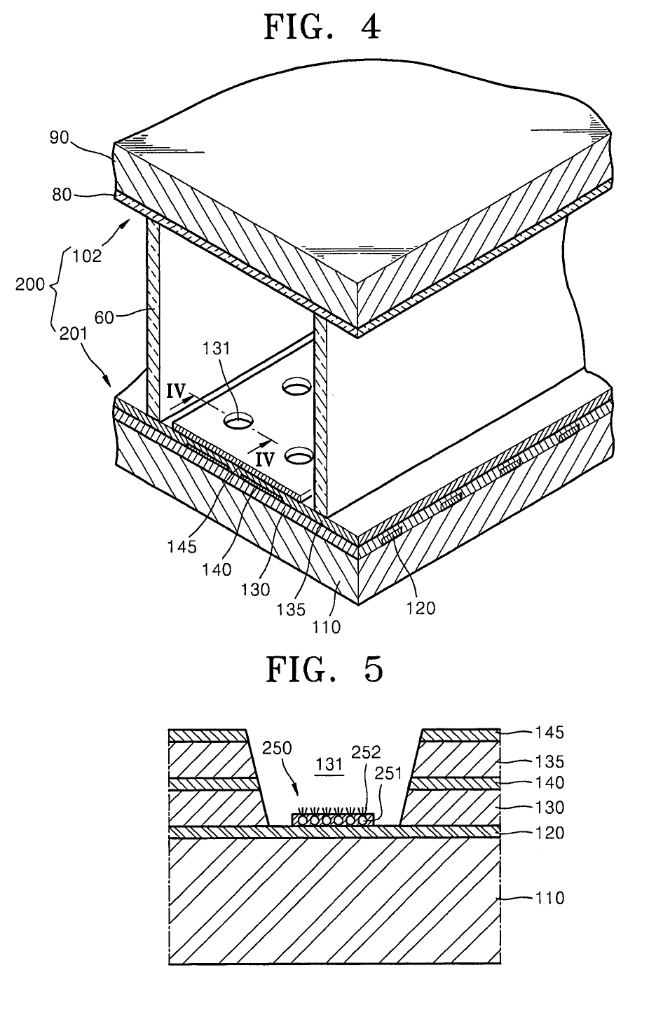

FIG. 4 illustrates a partially exploded perspective view of an electron emission device 201 according to an embodiment of the present invention. FIG. 5 illustrates a cross-sectional view taken along a line IV-IV of FIG. 4.

Referring to FIGS. 4 and 5, an electron emission device 201 may include a second insulation layer 135 covering an upper surface of the gate electrode 140, and a collimating electrode 145 may be on an upper surface of the second insulation layer 135 in addition to the constituents of the electron emission device 101 illustrated in FIG. 1. The collimating electrode 145 may collimate electrons emitted from the electron emission sources 250 toward the phosphor layers 70 (see FIG. 2), and the collimating electrode 145 may prevent the electrons from being dispersed in a lateral direction. When CNTs, which may be included in electron emission sources and function as an electron emission material, are grown from catalyst metal nano particles, the CNTs may not be condensed, but may be spaced part from each other, thereby avoiding the screen effect and increasing the electron emission efficiency.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An electron emission device, comprising:
a base substrate;
a plurality of first electrodes on the base substrate;
a first insulation layer on the first electrodes;
a plurality of second electrodes on the first insulation layer, the first insulation layer electrically insulating the first and second electrodes;
a plurality of electron emission source holes in the first insulation layer and the second electrodes to expose the first electrodes; and
a plurality of electron emission sources in the electron emission source holes, each electron emission source including at least one electron emission material and at least one catalyst metal nano particle.

2. The electron emission device as claimed in claim 1, wherein the catalyst metal nano particles comprise at least one of Fe, Co, or Ni.

3. The electron emission device as claimed in claim 1, wherein an average diameter of the catalyst metal nano particles is in a range of about 1 nm to about 10 nm.

4. The electron emission device as claimed in claim 1, wherein an average diameter of the catalyst metal nano particles is in a range of about 1 nm to about 5 nm.

5. The electron emission device as claimed in claim 1, further comprising:
a second insulation layer on the second electrodes; and
a collimating electrode on the second insulation layer.

6. The electron emission device as claimed in claim 1, further comprising:
a front substrate separated from the base substrate by spacers;
a third electrode on the front substrate; and
a plurality of phosphor layers on the third electrode, the phosphor layers corresponding to the emission sources.

7. The electron emission device as claimed in claim 6, wherein at least one of the phosphor layers is a red light emitting phosphor layer comprising SrTiO₃:Pr, Y₂O₃:Eu, or Y₂O₃S:Eu.

8. The electron emission device as claimed in claim 7, wherein at least one of the phosphor layers is a green light emitting phosphor layer comprising Zn(Ga, Al)₂O₄:Mn, Y₃(Al, Ga)₅O₁₂:Tb, Y₂SiO₅:Tb, or ZnS:Cu,Al.

9. The electron emission device as claimed in claim 7, wherein at least one of the phosphor layers is a blue light emitting phosphor layer comprising Y₂SiO₅:Ce, ZnGa₂O₄, or ZnS:Ag,Cl.

10. The electron emission device as claimed in claim 1, further comprising carbon nano tubes grown from the catalyst metal particles.

11. A method of manufacturing an electron emission device, comprising:
preparing a composition, the composition including catalyst metal nano particles;
coating the composition on a plurality of first electrodes to form a layer; and
growing at least one electron emission material from the catalyst metal nano particles.

12. The method as claimed in claim 11, further comprising:
exposing the layer;
partially hardening the layer; and
baking the layer.

13. The method as claimed in claim 11, wherein the coating the composition comprises:
preparing a base substrate;
forming the first electrodes extending in a direction on the base substrate;
forming an insulation layer to cover the electrodes;
forming a plurality of second electrodes on the first insulation layer to cross the first electrodes;
forming a plurality of electron emission source holes to expose the first electrodes and the second electrodes; and
coating the layer of the composition on the base substrate and the electron emission source holes.

14. The method as claimed in claim 11, wherein the coating the composition comprises:
preparing a base substrate;
forming the first electrodes extending in a direction on the base substrate;
forming a first insulation layer to cover the first electrodes;
forming a plurality of second electrodes on the first insulation layer to cross the first electrodes;
forming a second insulation layer to cover the first electrodes;
forming a collimating electrode on the second insulation layer;
forming a plurality of electron emission source holes to expose the first electrodes, the second electrodes, the second insulation layer, and the collimating electrode; and
coating the layer of the composition on the base substrate and the electron emission source holes.

15. The method as claimed in claim 11, wherein the composition is formed by dispersing massive polar and non-polar molecules and catalyst metal particles in a vehicle.

16. A composition for forming electron emission sources, comprising:
a dispersion of polar and non-polar massive molecules and catalyst metal particles in a vehicle.

17. The composition as claimed in claim 16, wherein the vehicle comprises:
at least one resin selected from cellulose resin, acrylate resin, or vinyl resin; and
at least one solvent selected from terpineol, butyl carbitol, butyl carbitol acetate, or 2,2,4-trimethyl-1,3-pentanediol monoisobutyrate.

18. An electron emission source, comprising:
catalyst metal nano particles; and
at least one electron emission material grown from the catalyst nano particles.

19. The electron emission source as claimed in claim 18, wherein the catalyst metal nano particles are formed of at least one of Fe, Co, or Ni.

20. The electron emission source as claimed in claim 18, wherein an average diameter of the catalyst metal nano particles is in a range of about 1 nm to about 10 nm.
